(19) United States
(12) Patent Application Publication
(10) Pub. No.: US 2017/0314438 A1
(43) Pub. Date: Nov. 2, 2017

(54) Exhaust System

(71) Applicant: Johnson Matthey Public Limited Company, London (GB)

(72) Inventors: Gavin BROWN, Royston (GB); Andrew CHIFFEY, Royston (GB); Jonathan RADCLIFFE, Royston (GB)

(21) Appl. No.: 15/499,997

(22) Filed: Apr. 28, 2017

Related U.S. Application Data
(60) Provisional application No. 62/329,313, filed on Apr. 29, 2016.

(51) Int. Cl. F01N 3/08; B01D 53/94; B01J 23/00; B01J 23/10; B01J 23/34; B01J 23/44; B01J 23/83; B01J 37/08; B01J 37/04; B01J 37/02; B01J 35/04; B01J 35/00; F01N 3/28

(52) U.S. Cl. CPC F01N 3/0814; F01N 3/2842; B01D 53/9481; B01J 23/005; B01J 23/10; B01J 23/34; B01J 23/44; B01J 23/83; B01D 53/9454; F01N 3/0842; B01J 37/088; B01J 37/086; B01J 37/04; B01J 37/0236; B01J 37/0219; B01J 35/04; B01J 35/0006; B01D 2255/1025; B01D 2255/9032; B01D 2255/91; B01D 2255/9155; B01D 2255/1021; B01D 2255/1023; F01N 2370/02

(57) ABSTRACT

An exhaust system for an internal combustion engine, the exhaust system comprising, a lean NOₓ trap (LNT), a wall flow monolithic substrate having a NOₓ storage and reduction zone thereon, the wall flow monolithic substrate having a pre-coated porosity of 40% or greater, the NOₓ storage and reduction zone comprising a platinum group metal loaded on a first support, the first support comprising one or more alkaline earth metal compounds, a mixed magnesium/aluminium oxide, cerium oxide, and at least one base metal oxide selected the group consisting of copper oxide, manganese oxide, iron oxide and zinc oxide.

The present invention relates to exhaust systems for internal combustion (IC) engines, to catalytic monolithic substrates for use in such exhaust systems, to methods of making such catalyzed substrates and to methods of treating exhaust gases.

Internal combustion engines are a potential source of pollutants. It would be desirable to reduce emission of pollutants from internal combustion engines. Furthermore, increasingly strict environmental regulations have come into force, and further regulations are planned, in economies such as the European Union, the USA and throughout the world to reduce the emission of pollutants into the atmosphere from various sources, in particular, internal combustion engines.

Pollutants of concern include NOₓ, carbon monoxide, particulates, hydrocarbons, hydrogen sulfide and ammonia. There have been a number of solutions proposed for reducing emissions from IC engines.

WO-A-2010/004320 discloses an exhaust system for a lean-burn internal combustion engine comprising a first substrate monolith comprising a catalyst for oxidising nitric oxide (NO) followed downstream by a wall-flow filter having inlet channels and outlet channels, where the inlet channels comprise a NOx absorber catalyst and the outlet channels comprise a catalyst for selective catalytic reduction of nitrogen oxides with nitrogenous reductant.

WO-A-2012/175948 discloses an exhaust system with a lean NOx trap and a catalyzed substrate for an internal combustion engine for treating a range of pollutants. The catalyzed substrate has a first zone and a second zone, wherein the first zone comprises a platinum group metal loaded on a support and the second zone comprises copper or iron loaded on a zeolite. The first zone or second zone additionally comprises a base metal oxide or a base metal loaded on an inorganic oxide.

WO-A-2005/014146 discloses a catalyst arrangement using a single monolith and a method of purifying the exhaust gas of internal combustion engines operated under lean conditions. A thin-walled, porous carrier is coated on one side with a nitrogen oxide storage catalyst and on the other side with an SCR catalyst.

Nitrogen oxides (NOₓ) can be produced, for example, when nitrogen in the air reacts with oxygen within an IC engine. Such nitrogen oxides can include nitrogen monoxide and/or nitrogen dioxide.

One catalytic method to reduce NOₓ emissions is the lean NOₓ trap with an oxidation catalyst which efficiently converts NOₓ produced in an internal combustion engine to nitrogen, although some exhaust gas NOₓ can slip through as the trap becomes saturated. Some byproducts can also be produced by a lean NOₓ trap, for example, non-selective reduction pathways can result in the production of ammonia.

When exhaust gas is produced in lean conditions (low fuel/oxygen ratio), NOx is adsorbed on the lean NOx adsorber trap (LNT). The LNT is regenerated by contacting it intermittently with enriched (high fuel/oxygen ratio) exhaust gas (produced under the control of engine management systems). Such enrichment promotes desorption of adsorbed NOx and reduction of NOx on a reduction catalyst present in the LNT. The enriched exhaust gas also generates ammonia (NH₃) from NOx.

NOₓ traps can store high concentrations of sulphur during standard operation. This sulphur needs to be removed periodically in order to maintain performance of the NOx trap. High temperature lean/rich cycling is used to desulphate the catalyst. However, this process causes the release of H₂Sto the environment. Although H₂S is not currently a regulated pollutant, it would be beneficial to provide a means of reducing hydrogen sulphide emissions.

WO-A-2014/080220 discloses a zoned catalyst on a monolithic substrate for controlling hydrogen sulfide gas formed in a lean NOₓ trap during desulfation.

It is, however, difficult to reduce H₂S release whilst maintaining good performance of catalysts for other pollutants and maintaining good filtration of particulates.

US-A-2011/0014099 discloses a catalytically active particulate filter which has a hydrogen sulphide block function.

US-A-2008/214390 discloses a catalyst for purifying an exhaust gas which is capable of restraining emission of hydrogen sulphide.

US-A-2009/082199 discloses a catalyst adapted to purify exhaust gases from an IC engine and in particular which is capable of restraining emission of hydrogen sulphide. The platinum group metal catalysts and the oxides are described as being separated in this disclosure to avoid deterioration/poisoning of the PGM catalyst.

Separation of the H₂S-reducing materials and PGM in a catalyst washcoat for use on a filter substrate can result in significant reduction in porosity of the filter substrate because multi-layer or thick catalysts tend to block channels and pores in filter substrates. Reduction in porosity tends to reduce the effectiveness of filter substrates as particle filters. Furthermore, separation of the catalytic components can require the use of further monoliths which can be difficult in some exhaust systems where space is at a premium.

There is, therefore, a continuing need to reduce emissions of H₂S without also reducing the effectiveness of catalytic removal of other pollutants such as particulates, hydrocarbons and CO, in particular as new regulations reduce the allowable level of emissions from IC engines.

It is an aim of the present invention to address these issues.

The present invention accordingly provides, in a first aspect, an exhaust system for an internal combustion engine, the exhaust system comprising, a lean NOₓ trap (LNT), a wall flow monolithic substrate having a NOₓ storage and reduction zone thereon, the wall flow monolithic substrate having a pre-coated porosity of 40% or greater (preferably in the range 40% to 75%), the NOₓ storage and reduction zone comprising a platinum group metal loaded on a first support, the first support comprising one or more alkaline earth metal compounds, a mixed magnesium/aluminium oxide, cerium oxide, and at least one base metal oxide selected the group consisting of copper oxide, manganese oxide, iron oxide and zinc oxide. There may be a mixture of two or more base metal oxides.

This is greatly advantageous, because such an exhaust system results in reduction of emissions of NOₓ and particulates, together with CO and hydrocarbons. Furthermore, the exhaust system advantageously, reduces emission of H₂S. Reducing NOₓ, H₂S and particulate emissions as achieved in a single monolith by exhaust systems of the present invention is greatly advantageous.

The relatively high porosity of the wall flow monolithic substrate enables effective catalytic activity and particulate filtering even with more challenging recent drive test cycles for IC engines in vehicles. Furthermore, the use of base metal oxide according to the invention significantly reduces the emissions of H₂S formed during desulphation on the LNT whilst maintaining efficient adsorption of NOₓ even when the base metal oxide is combined in the PGM washcoat. Surprisingly, the use of base metal oxides does not poison the PGM and does not significantly affect the NOₓ storage and reduction zone. This allows the base metal, NOₓ storage and reduction materials (e.g. alkaline earth metal compounds, preferably barium compounds) and PGM to be present in a single washcoat which can reduce the thickness of the catalyst coating on the porous monolith and thereby maintains good particulate performance and reduces the potential for unacceptable back-pressure.

Preferably, the base metal oxide comprises zinc oxide. Preferably, zinc oxide can be incorporated in the washcoat. Alternatively, zinc oxide in the first support can be derived from generally a suitable zinc compound (for example zinc nitrate, zinc carbonate, zinc hydroxide or a mixture of two or more thereof) incorporated in the washcoat that decomposes to form zinc oxide during subsequent firing.

Preferably, the first support comprises 1 wt % or less zirconia. It is preferred that the cerium oxide does not comprise zirconium or zirconium oxide.

The first support will usually comprise particulate materials, preferably having a particle size (e.g. d₉₀ particle size) in the range 1 μm to 25 μm, more preferably 2 μm to 20 μm, even more preferably 2 μm to 15 μm, or 2 μm to 12 μm and most preferably 4μm to 10 μm.

Preferably, the, or each, alkaline earth metal compound comprises an oxide, carboxylate (e.g. acetate), carbonate and/or hydroxide of magnesium, calcium, strontium or barium or a mixture of any two or more of these compounds. More preferably, the alkaline earth metal compound comprises a barium compound. Although the alkaline earth metal compound can be present as an oxide, carboxylate (e.g. acetate), carbonate and/or hydroxide during preparation of the catalyst, in the presence of air or lean engine exhaust gas some or most of the alkaline earth metal species, for example barium, can be in the form of the oxide, carbonate and/or hydroxide.

The mixed magnesium/aluminium oxide can comprise magnesium doped alumina. The mixed magnesium/aluminium oxide can comprise a magnesium aluminate spinel.

Preferably, the mixed magnesium/aluminium oxide comprises magnesium in the amount of 0.1 wt % to 12 wt %, based on the weight of the mixed magnesium/aluminium oxide.

It is preferred that the first support comprises the alkaline earth metal compound (preferably one or more barium compounds) at a loading in the range of 90 to 200 g/ft³, based on the weight of the alkaline earth metal.

The first support will usually comprise the base metal oxide at a loading in the range of 100 to 300 g/ft³ based on the weight of the base metal (as Zn, Cu, Fe and/or Mn as appropriate).

Preferably, the platinum group metal is selected from platinum, palladium, rhodium, or mixtures thereof. The preferred platinum group metal comprises a mixture of platinum and palladium in a Pt:Pd weight ratio in the range 2:1 to 8:1. The Pt:Pd weight ratio is preferably greater than 3:1, preferably greater than 4:1 and more preferably 3:1 to 7:1, most preferably 4:1 to 6:1.

It is preferred that the total platinum group metal loading in the NOₓ storage and reduction zone is in the range 5 to 100 g/ft³, preferably 10 to 90 g/ft³, more preferably in the range in the range 20 to 80 g/ft³, more preferably in the range 30 to 70 g/ft³, and most preferably in the range 40 to 60 g/ft³, based on the weight of the PGM.

Usually, the pre-coated porosity of the wall flow monolithic substrate will be 40% or greater, 41% or greater, 42% or greater, preferably 43% or greater. Higher porosities of 47% or greater, 49% or greater, 51% or greater, 55% or greater and 59% or greater, 60% or greater, 61% or greater or 62% or greater can also be useful. Generally, the pre-coated porosity of the wall flow monolithic substrate will be 75% or lower, and may be 70% or lower. The pre-coated porosity of the wall flow monolithic substrate may be in the ranges 40% to 75%, 41% to 75%, 42% to 70% or 42% to 67%.

This is advantageous because such relatively high porosities enable good exhaust gas flow through the channel walls in the monolithic substrate effectively enhancing the interaction between the oxidation catalytic zone and the exhaust gases and hence conversion but, because of the advantageous nature of the base metal oxide, without increasing back pressure unacceptably.

Advantageously, the NOₓ storage and reduction zone can be applied to be in a single layer to thereby reduce the thickness of the catalytic layer in the wall flow filter and thereby reduce back pressure in the high porosity wall flow filter.

The washcoat loading of the NOₓ storage and reduction zone can be in the range 0.5 to 3.0 g/in³, based on the dry weight of the washcoat.

It can be advantageous that the exhaust system of the present invention further comprises an additional catalytic zone. An example of an additional catalytic zone that can be advantageous is a selective catalytic reduction zone on a monolithic substrate, the selective catalytic reduction zone comprising copper or iron loaded on a second support, the second support comprising a molecular sieve.

The zeolite can be selected from a beta zeolite (BEA), a faujasite (FAU) (such as an X-zeolite or a Y-zeolite, including NaY and USY), an L-zeolite, a chabazite, a ZSM zeolite (e.g., ZSM-5 (MFI), ZSM-48 (MRE)), a so-called small pore molecular sieve having a maximum pore opening of eight tetrahedral atoms, preferably CHA, ERI or AEI, an SSZ-zeolite (e.g., SSZ-13 (a CHA), SSZ-41, SSZ-33, SSZ-39), a ferrierite (FER), a mordenite (MOR), an offretite (OFF), a clinoptilolite (HEU), a silicalite, an aluminiophosphate molecular sieve (including metalloaluminophosphates such as SAPO-34 (a CHA)), a mesoporous zeolite (e.g., MCM-41, MCM-49, SBA-15), or mixtures thereof; more preferably, the zeolite is a beta zeolite (BEA), a ferrierite (FER), or a small pore molecular sieve selected from CHA, ERI and AEI; most preferably aluminosilicate CHA or AEI.

The washcoat loading of the selective catalytic zone, if present, can be in the range 0.5 to 3.0 g/in³. Cu is preferred in the selective catalytic reduction zone.

The NOₓ storage and reduction zone and the selective catalytic reduction zone (if present) can each be on portions of the same monolithic wall flow substrate. This is particularly advantageous where there is restricted space in an exhaust system e.g. of a vehicle and allows compact and less complex systems to be provided.

A great advantage of the use of a wall flow monolithic substrate is that the substrate acts as a filter substrate reducing particulate emissions very effectively. A wall flow monolithic substrate usually comprises an inlet end, an outlet end, with an axial length extending between the inlet end and the outlet end, and a plurality of channels defined by internal walls of the wall flow substrate. The channels of the wall-flow filter are alternately blocked from either the inlet or outlet end so that the channels comprise inlet channels having an open inlet end and a closed outlet end and outlet channels having a closed inlet end and open outlet end. This ensures that the exhaust gas stream enters a channel from the inlet end, flows through the porous channel walls, and exits the filter from a different channel leading to the outlet end. Particulates in the exhaust gas stream are effectively trapped in the filter.

The NOₓ storage and reduction zone can be disposed in channels of the wall flow monolithic substrate from one end thereof and the selective catalytic reduction zone can be disposed in channels of the wall flow monolithic substrate from the other end thereof.

Where the NOₓ storage and reduction zone and the selective catalytic reduction zone are on portions of the same monolithic wall flow substrate, the NOₓ storage and reduction zone can extend over between 10% and 90% of the axial length of the monolithic substrate and the selective catalytic reduction zone extends over between 90% and 10%

Thus, an axial length of the NOₓ storage and reduction zone and an axial length of the selective catalytic reduction zone can overlap by 20% or less of a total axial length of the monolithic substrate.

The NOₓ storage and reduction zone can be upstream or downstream of the selective catalytic zone, but is preferably upstream. The NOₓ storage and reduction zone is usually present on the inlet channels of the inlet end of the wall flow monolithic substrate and the selective catalytic reduction zone is present on the outlet channels of the outlet end of the wall flow monolithic substrate. This orientation is preferable especially in higher temperature exhaust systems because it is advantageous for the SCR zone to be in the cooler location relative to the NOₓ storage and reduction zone to reduce ammonia slip.

It is preferred that the pores of the wall flow monolithic substrate have a pre-coated diameter (mean pore size, MPS) in the range 9 μm to 25 μm. This range of pore diameter is suitable for washcoat coating by which the catalysts and supports can be applied to the walls of the channels, enabling a relatively high surface area for catalytic activity without increasing back pressure unacceptably. MPS can be determined by mercury porosimetry.

Preferably, the wall flow monolithic substrate comprises an inlet end having inlet channels and an outlet end having outlet channels and the NOₓ storage and reduction zone is on and/or within the walls of both the inlet channels of the inlet end of the monolithic substrate and on and/or within the walls of the outlet channels of the outlet end of the monolithic substrate.

The present invention provides, in a second aspect, a catalytic wall flow monolithic substrate, the wall flow monolithic substrate having a NOₓ storage and reduction zone thereon, the wall flow monolithic substrate having a pre-coated porosity of 40% or greater , the NOₓ storage and reduction zone comprising a platinum group metal loaded on a first support, the first support comprising an alkaline earth metal compound a mixed magnesium/aluminium oxide, cerium oxide, and a base metal oxide selected from copper oxide, manganese oxide, iron oxide or zinc oxide.

The optional and preferred features of the second aspect of the invention correspond to those optional and preferred features of the first aspect.

Usually, the NOₓ storage and reduction zone can be deposited on the substrate using washcoat procedures. A general process for preparing the monolith substrate using a washcoat procedure is set out below.

Washcoating is preferably performed by slurrying (e.g. in water) solid particles making up the support (including one or more alkaline earth metal compounds, a mixed magnesium/aluminium oxide, cerium oxide, and a base metal oxide) so that they have a particle size of less than 20 microns, preferably 10 microns or lower, in an average diameter (e.g. d₉₀). The slurry preferably contains between 4 to 40 weight percent solids, more preferably between 6 to 30 weight percent solids. Additional components, such as stabilizers or promoters can also be incorporated in the slurry as a mixture of water soluble or water-dispersible compounds or complexes. The substrate can then be coated one or more times with the slurry such that there will be deposited on the substrate the desired loading of catalytic materials.

The platinum group metal can be added to the support-coated substrate monolith by any known means, including impregnation, adsorption, or ion-exchange of a platinum compound (such as platinum nitrate), but is conveniently added to the washcoat slurry as a soluble platinum group metal salt or salts.

In a third aspect, the present invention accordingly provides, method of making a catalysed monolithic substrate, the method comprising providing a wall flow monolithic substrate, the wall flow monolithic substrate having a pre-coated porosity of 40% or greater preparing a NOₓ storage and reduction zone washcoat comprising a source of a platinum group metal, a source of an alkaline earth metal compound and a mixed magnesium/aluminium oxide, cerium oxide, and at least one base metal oxide selected from the group consisting of copper oxide, manganese oxide, iron oxide and zinc oxide, and applying the NOₓ storage and reduction zone washcoat to at least a first portion of the monolithic substrate.

The exhaust system of the first aspect is greatly advantageous in reducing emissions of NOₓ, H₂S, particulates, HC and CO from IC engines.

Thus, in a fourth aspect, the present invention accordingly provides, a method of treating exhaust gases from an internal combustion engine, the method comprising flowing the exhaust gas through an exhaust system according to the first aspect, wherein the exhaust gas comprises a lean exhaust gas intermittently becoming rich.

The terms “lean” and “rich” are relative to the stoichiometric point of fuel combustion in the engine, i.e. the air to fuel ratio by weight that combusts the fuel perfectly as hydrocarbon plus oxygen to carbon dioxide and water. Lean exhaust gases are formed when air is in excess of this stoichiometric point, rich exhaust gases are formed when fuel is in excess.

In a fifth aspect, the present invention according provides, a compression ignition engine fitted with an exhaust system according to the first aspect.

In a sixth aspect, the present invention according provides, a vehicle comprising a compression ignition engine according to the fifth aspect.

The above and other characteristics, features and advantages of the present invention will become apparent from the following detailed description, taken in conjunction with the accompanying drawings and the Examples, which illustrate, by way of example, the principles of the invention.

Reference throughout this specification to “an aspect” means that a particular feature, structure or characteristic described in connection with the aspect is included in at least one aspect of the present invention. Thus, appearances of the phrase “in an aspect” in various places throughout this specification are not necessarily all referring to the same aspect, but can refer to different aspects. Furthermore, the particular features, structures or characteristics of any aspect of the invention can be combined in any suitable manner, as would be apparent to one of ordinary skill in the art from this disclosure, in one or more aspects.

In the description provided herein, numerous specific details are set forth. However, it is understood that the invention can be practised without these specific details. In other instances, well-known methods, structures and techniques have not been shown in detail in order not to obscure an understanding of this description.

In order that the present invention can be better understood, reference is made to accompanying drawings, in which:

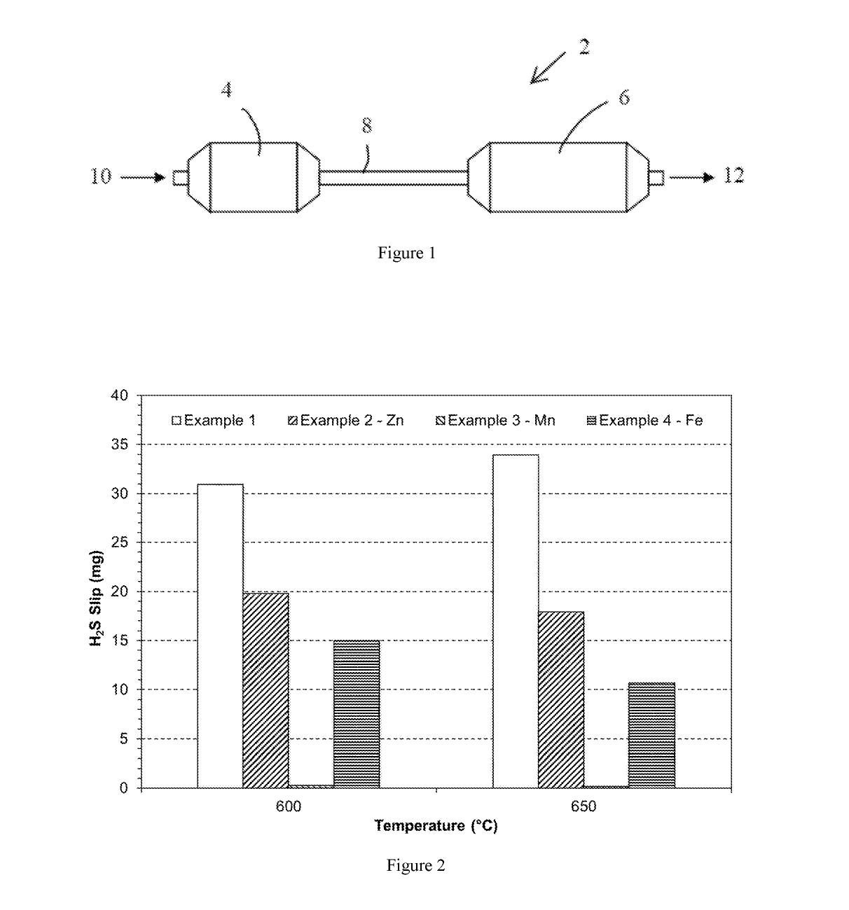

FIG. 1 illustrates schematically an exhaust system according to the present invention.

FIG. 2 shows a graph of the amount of H₂S slip (in mg) with inlet temperature of 600° C. and 650° C. for Examples 1, 2, 3 and 4.

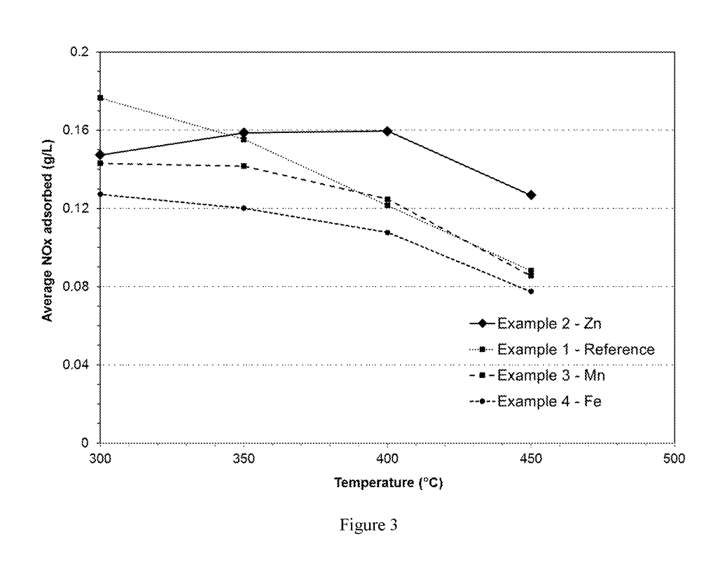

FIG. 3 shows a graph of average NOx adsorbed as function of inlet temperature over the range of 300° C. to 450° C. for Examples 1, 2, 3 and 4

FIG. 1 shows schematically a first exhaust system 2 of the present invention. The exhaust system 2 comprises a first monolithic substrate 4 which forms a lean NOₓ trap (LNT) catalyst. The exhaust gases from the engine (not shown) upstream of the first monolithic substrate/lean NOₓ trap 4 enter the first monolithic substrate 4 through inlet 10 and exit the first monolithic substrate 4 through pipe 8. The exhaust gases then enter a second monolithic substrate 6 before exiting through outlet 12. Downstream of outlet 12 there can be other catalytic zones (for example a passive or active selective catalytic reduction zone) or the exhaust gases can be released to atmosphere.

The second monolithic substrate 6 is a filter, wall flow SiC monolith substrate of 63% porosity having a honeycomb structure with many small, parallel thin-walled channels running axially through the substrate, with the channels of the wall flow substrate being alternately blocked, which allows the exhaust gas stream to enter a channel from the inlet, then flow through the porous channel walls, and exit the filter from a different channel leading to the outlet. The second monolithic substrate 6 is coated (using washcoat processes) with a NOₓ storage and reduction catalyst comprising Pt:Pd at a weight ratio of 5:1 (total PGM loading of 48 g ft⁻³) and a support of Ce/magnesium aluminate, cerium oxide, barium acetate and zinc oxide (as base metal oxide, zinc loading of 250 g ft⁻³). The base metal oxide can alternatively or additionally comprise copper oxide, manganese oxide and/or iron oxide. The second monolithic substrate 6 of FIG. 1 can be formed as described below in the Examples.

The following Examples are provided by way of illustration only.

### EXAMPLE 1

Ce/magnesium-aluminate spinel was slurried in water and milled to a d₉₀ of less than 10 micron. Water soluble salts of Pt and Pd were added followed by cerium oxide and barium acetate. The mixture was stirred to homogenise and form a coating slurry. The coating slurry was applied to a 3.0 litre volume SiC wall-flow filter substrate having 300 cells per square inch, a wall thickness of 12.5 Mil (thousands of an inch) and 63% porosity. The coating was dried using forced air flow and calcined at 500° C.

The finished catalyst coating on the filter had a Pt:Pd weight ratio of 5:1 and total PGM loading of 48 g ft⁻³.

### EXAMPLE 2

### Zinc

Ce/magnesium-aluminate spinel was slurried in water and milled to d₉₀ of less than 10 micron. Soluble salts of Pt and Pd were added followed by cerium oxide and barium acetate. Zn oxide was added to the slurry and the mixture stirred to homogenise. The coating slurry was applied to a 3.0 litre volume SiC wall-flow filter substrate having 300 cells per square inch, a wall thickness of 12.5 Mil (thousands of an inch) and 63% porosity. The coating was dried using forced air flow and calcined at 500° C.

The finished catalyst coating on the filter had a zinc loading of 250 g ft⁻³, a Pt:Pd weight ratio of 5:1 and total PGM loading of 48 g ft⁻³.

### EXAMPLE 3

### Manganese

Ce/magnesium-aluminate spinel was slurried in water and milled to d₉₀ of less than 10 micron. Soluble salts of Pt and Pd were added followed by cerium oxide and barium acetate. Mn dioxide was added to the slurry and the mixture stirred to homogenise. The coating slurry was applied to a 3.0 litre volume SiC wall-flow filter substrate having 300 cells per square inch, a wall thickness of 12.5 Mil (thousands of an inch) and 63% porosity. The coating was dried using forced air flow and calcined at 500° C.

The finished catalyst coating on the filter had a manganese loading of 250 g ft⁻³, a Pt:Pd weight ratio of 5:1 and total PGM loading of 48 g ft⁻³.

### EXAMPLE 4

### Iron

Ce/magnesium-aluminate spinel was slurried in water and milled to d₉₀ of less than 10 micron. Soluble salts of Pt and Pd were added followed by cerium oxide and barium acetate. Ferrous hydroxide was added to the slurry and the mixture stirred to homogenise. The coating slurry was applied to a 3.0 litre volume SiC wall-flow filter substrate having 300 cells per square inch, a wall thickness of 12.5 Mil (thousands of an inch) and 63% porosity. The coating was dried using forced air flow and calcined at 500° C.

The finished catalyst coating on the filter had an iron loading of 250 g ft⁻³, a Pt:Pd weight ratio of 5:1 and total PGM loading of 48 g ft⁻³.

### EXAMPLE 5

### Controlling H₂S Performance

The H₂S controlling performance of the coated filters was determined using a laboratory synthetic gas bench test. Core samples were taken from catalyst of each of the Examples. The cores were hydrothermally aged at 800° C. for 16 hours. Lean and rich simulated exhaust gas mixtures were used to represent those produced during the desulphation of a lean NOₓ trap. The reactor was heated to the first evaluation temperature and a lean gas mix was passed through the sample for 20 seconds. The gas mix was then switched to a rich gas mix for 20 seconds. This cycle of alternating lean and rich gas mixes was repeated during the test. The temperature was then increased to the next evaluation point and the lean/rich sequence repeated. Gas mix concentrations are given in Table 1, with the balance being nitrogen in both cases.

TABLE 1

| | Lean gas mix | Rich gas mix |
|---|---|---|
| CO₂ | 14% | 14% |
| HC | 120 ppm (C₁) | 2000 ppm (C₁) |
| O₂ | 1.7% | 0 |
| H₂O | 5% | 5% |
| H₂ | 0 | 0.07% |
| CO | 0 | 0.24% |
| H₂S | 0 | 500 ppm |

The concentration of H₂S downstream of the filter sample was continuously measured and the peak concentration of H₂S was determined at temperatures of 600 and 650° C. This peak value at each temperature is termed the H₂S slip at that temperature. FIG. 2 shows that Example 1 exhibits more H₂S slip than Examples 2, 3 and 4 at temperatures between 600° C. and 650° C.

### EXAMPLE 6

### Controlling NOx Storage Performance

The NOx storage performance of the coated filters was determined using a laboratory synthetic gas bench test. Core samples were taken from catalyst examples 1, 2, 3 and 4.

The cores were hydrothermally aged at 800° C. for 16 hours. The reactor was heated to the first evaluation temperature and a lean gas mix was passed through the sample for 300 seconds. The gas mix was then switched to a rich gas mix for 16 seconds. This cycle of alternating lean and rich gas mixes was repeated a further 9 times during the test. The temperature was then increased to the next evaluation point and the lean/rich sequence repeated. Gas mix concentrations are given in Table 2, with the balance being nitrogen in both cases.

TABLE 2

| | Lean gas mix | Rich gas mix |
|---|---|---|
| CO₂ | 6% | 10.3% |
| C₃H₆ | 45 ppm | 1700 ppm |
| O₂ | 10.5% | 1.45% |
| H₂O | 6.6% | 12% |
| H₂ | 0% | 0.4% |
| CO | 0.03% | 2% |
| NO | 100 ppm | 200 ppm |
| Space Velocity | 62,000 h⁻¹ | 52,000 h⁻¹ |

The amount of NOx stored was calculated as the mean NOx stored as NO₂ in grams per litre of catalyst volume (g/L) over the 10 lean/rich cycles at each temperature evaluation point. The results are shown in FIG. 3.

FIG. 3 shows that Example 2 which comprises Zn has greater NOx storage than Examples 3 and 4, which comprise Mn and Fe respectively. The greater NOx storage from Example 2 is higher at higher temperatures (above about 300° C.).

1. An exhaust system for an internal combustion engine, the exhaust system comprising,
a) a lean NOₓ trap,
b) a wall flow monolithic substrate having a NOₓ storage and reduction zone thereon, the wall flow monolithic substrate having a pre-coated porosity of 40% or greater, the NOₓ storage and reduction zone comprising a platinum group metal loaded on a first support, the first support comprising one or more alkaline earth metal compounds, a mixed magnesium/aluminium oxide, cerium oxide, and at least one base metal oxide selected the group consisting of copper oxide, manganese oxide, iron oxide and zinc oxide.

2. The exhaust system according to claim 1, wherein the base metal oxide comprises zinc oxide.

3. The exhaust system according to claim 1, wherein the first support comprises 1 wt % or less zirconia.

4. The exhaust system according to claim 1, wherein the, or each, alkaline earth metal compound comprises an oxide, carboxylate, carbonate and/or hydroxide of magnesium, calcium, strontium or barium or a mixture of any two or more of these compounds.

5. The exhaust system as claimed in claim 1, wherein the mixed magnesium/aluminium oxide comprises magnesium doped alumina.

6. The exhaust system according to claim 1, wherein the mixed magnesium/aluminium oxide comprises ceria spray-dried on to magnesium doped alumina.

7. The exhaust system according to claim 1, wherein the mixed magnesium/aluminium oxide comprises magnesium in the amount of 0.1 wt % to 12 wt % based on the weight of the mixed magnesium/aluminium oxide.

8. The exhaust system according to claim 1, wherein the mixed magnesium/aluminium oxide comprises a magnesium aluminate spinel.

9. The exhaust system according to claim 1, wherein the first support comprises the alkaline earth metal at a loading in the range of 90 to 200 g/ft³ based on the weight of the alkaline earth metal.

10. The exhaust system according to claim 1, wherein the first support comprises the base metal oxide at a loading in the range of 100 to 300 g/ft³, based on the weight of the metal.

11. The exhaust system according to claim 1, wherein the platinum group metal is selected from the group consisting of platinum, palladium, rhodium, and mixtures of any two or more thereof

12. The exhaust system according to claim 11, wherein the platinum group metal comprises a mixture of platinum and palladium in a Pt:Pd weight ratio in the range 2:1 to 8:1.

13. (canceled)

14. The exhaust system according to claim 1, wherein the pre-coated porosity of the wall flow monolithic substrate is 40% or greater.

15. The exhaust system according to claim 1, wherein the NOₓ storage and reduction zone is applied to be in a single layer.

16. (canceled)

17. The exhaust system according to clam 1, wherein the wall flow monolithic substrate comprises pores having a diameter, the pores of the wall flow monolithic substrate have a pre-coated mean pore diameter in the range 9 μm to 25 μm.

18. The exhaust system according to claim 1, wherein the wall flow monolithic substrate comprises an inlet end having inlet channels and an outlet end having outlet channels and the NOₓ storage and reduction zone is on and/or within the walls of the inlet channels of the inlet end of the monolithic substrate and/or is on and/or within the walls of the outlet channels of the outlet end of the monolithic substrate.

19. A catalytic wall flow monolithic substrate, the wall flow monolithic substrate having a NOₓ storage and reduction zone thereon, the wall flow monolithic substrate having a pre-coated porosity of 40% or greater , the NOₓ storage and reduction zone comprising a platinum group metal loaded on a first support, the first support comprising an alkaline earth metal compound a mixed magnesium/aluminium oxide, cerium oxide, and a base metal oxide selected from copper oxide, manganese oxide, iron oxide or zinc oxide.

20. A method of making a catalysed monolithic substrate, the method comprising
a) providing a wall flow monolithic substrate, the wall flow monolithic substrate having a pre-coated porosity of 40% or greater preparing a NOₓ storage and reduction zone washcoat comprising a source of a platinum group metal, a source of an alkaline earth metal compound and a mixed magnesium/aluminium oxide, cerium oxide, and at least one base metal oxide selected from the group consisting of copper oxide, manganese oxide, iron oxide and zinc oxide, and
b) applying the NOₓ storage and reduction zone washcoat to at least a first portion of the monolithic substrate.

21. A method of treating exhaust gases from an internal combustion engine, the method comprising flowing the exhaust gas through an exhaust system according to claim 1, wherein the exhaust gas comprises a lean exhaust gas intermittently becoming rich.

22. A compression ignition engine fitted with an exhaust system according to claim 1.

23. A vehicle comprising a compression ignition engine according to claim 22.
